(19) United States
(12) Patent Application Publication
(10) Pub. No.: US 2023/0179757 A1
(43) Pub. Date: Jun. 8, 2023

(54) CONTROL DEVICE, CONTROL METHOD, AND RECORDING MEDIUM

(71) Applicant: HONDA MOTOR CO., LTD., Tokyo (JP)

(72) Inventors: Tatsuro FUJIWARA, Tokyo (JP); Yasushi SHODA, Tokyo (JP); Jumpei MORITA, Tokyo (JP)

(73) Assignee: HONDA MOTOR CO., LTD., Tokyo (JP)

(21) Appl. No.: 18/072,086

(22) Filed: Nov. 30, 2022

(30) Foreign Application Priority Data
Dec. 3, 2021 (JP) 2021-196996

(51) Int. Cl. H04N 13/398; H04N 13/243; H04N 13/189

(52) U.S. Cl. CPC H04N 13/398; H04N 13/243; H04N 13/189

(57) ABSTRACT

A control device includes circuitry configured to: generate, based on imaging data obtained by an imaging device of a moving body, a three-dimensional image indicating a space including both the moving body and surroundings of the moving body; enable manual rotation in which the space in the three-dimensional image is manually rotated and automatic rotation in which the space in the three-dimensional image is automatically rotated; and cause a display device to display the generated three-dimensional image. In response to rotation being switched from the manual rotation to the automatic rotation due to an operation by the user of the moving body, the circuitry starts the automatic rotation from a position that is based on a stop position of the space after the manual rotation.

### CROSS-REFERENCE TO RELATED APPLICATIONS

This application is based on and claims priority under 35 USC 119 from Japanese Patent Application No. 2021-196996 filed on Dec. 3, 2021, the contents of which are incorporated herein by reference.

### TECHNICAL FIELD

The present disclosure relates to a control device, a control method, and a recording medium storing a control program.

### BACKGR OUND

In recent years, as a specific measure against global climate change, efforts for realizing a low-carbon society or a decarbonized society have become active. Also in vehicles, reduction in CO₂ emission is strongly required, and autonomous driving of vehicles and introduction of driving assistance that contribute to improvement in fuel efficiency are rapidly progressing. In the related art, there's a known image generation method in which a predetermined range is imaged by each of cameras mounted on the front, rear, left, and right sides of a vehicle, and a surroundings image (for example, a bird's-eye view image and a three-dimensional image) of the vehicle and the surroundings of the vehicle is generated based on a combined image of the captured images. Japanese Patent Application Laid-Open Publication No. 2013-236374 (hereinafter, referred to as Patent Literature 1) discloses a control system that enables a generated three-dimensional image to be rotated automatically or manually.

For example, when displaying a rotatable three-dimensional image on a display screen or the like, viewability of the image by the display method is required. In particular, for example, when displaying a three-dimensional image by switching between automatic rotation and manual rotation, viewability of the display image at the time of switching is required.

However, Patent Literature 1 does not describe visibility of an image displayed on a display screen at the time when switching between automatic rotation and manual rotation is performed. Therefore, there is room for improvement in image visibility at the time of displaying a three-dimensional image by switching between automatic rotation display and manual rotation display.

An object of the present disclosure is to provide a control device, a control method, and a recording medium storing a control program capable of improving visibility of a three-dimensional image at the time of displaying the three-dimensional image on a display device, in which the three-dimensional image can be switched between automatic rotation display and manual rotation display.

### SUMMARY

The present disclosure relates to a control device, including

circuitry configured to:

generate, based on imaging data obtained by an imaging device of a moving body, a three-dimensional image indicating a space including both the moving body and surroundings of the moving body; and

cause a display device to display the generated three-dimensional image,

wherein the circuitry is capable of manual rotation in which the space in the three-dimensional image is manually rotated and automatic rotation in which the space in the three-dimensional image is automatically rotated, and.

wherein in response to rotation being switched from the manual rotation to the automatic rotation due to an operation by the user of the moving body, the circuitry starts the automatic rotation from a position that is based on a stop position of the space after the manual rotation.

According to the control device, the control method, and the control program of the present disclosure, it is possible to improve the visibility of a three-dimensional image at the time of displaying the three-dimensional image on a display device, in which the three-dimensional image can be switched between automatic rotation display and manual rotation display.

### BRIEF DESCRIPTION OF DRAWINGS

FIG. 1 is a side view illustrating an example of a vehicle on which a control device of the present embodiment is mounted;

FIG. 2 is a top view of the vehicle illustrated in FIG. 1;

FIG. 3 is a block diagram illustrating an internal configuration of the vehicle illustrated in FIG. 1;

FIG. 4 is a diagram illustrating an example of a three-dimensional image generated using respective pieces of imaging data of a plurality of cameras;

FIG. 5 is a diagram illustrating a three-dimensional image obtained by rotating the three-dimensional image illustrated in FIG. 4 by a predetermined angle;

FIG. 6 is a flowchart illustrating an example of display control performed by a control ECU;

FIG. 7 is a diagram schematically illustrating a display viewpoint of a three-dimensional image at the time of rotation switching in the display control in FIG. 6;

FIG. 8 is a flowchart illustrating another example of the display control of the control ECU; and

FIG. 9 is a diagram schematically illustrating a display viewpoint of a three-dimensional image at the time of rotation switching in the display control in FIG. 8.

### DESCRIPTION OF EMBODIMENTS

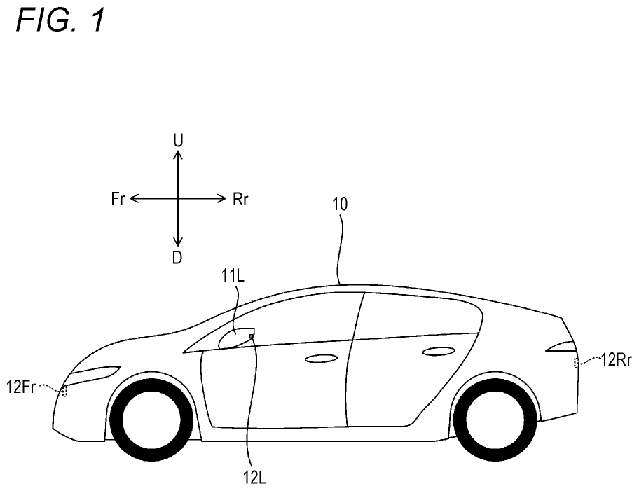

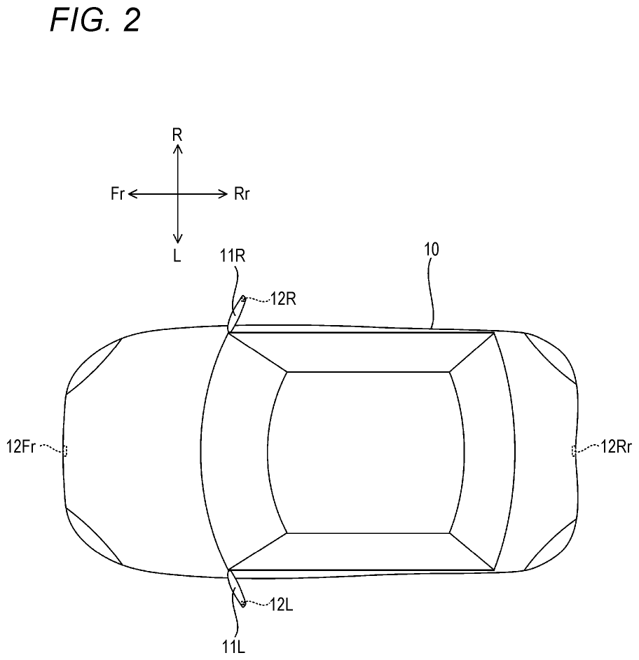

Hereinafter, an embodiment of a control device, a control method, and a control program according to the present disclosure will be described with reference to the accompanying drawings. Note that the drawings are to be viewed according to orientation of the reference signs. In the present specification and the like, in order to simplify and clarify the description, a front-rear direction, a left-right direction, and an up-down direction are described in accordance with directions viewed from a driver of a vehicle 10 illustrated in FIGS. 1 and 2. In the drawings, a front side of the vehicle 10 is denoted by Fr, a rear side thereof is denoted by Rr, a left side thereof is denoted by L, a right side thereof is denoted by R, an upper side thereof is denoted by U, and a lower side thereof is denoted by D.

<Vehicle 10 on which Control Device of Present Disclosure is Mounted>

FIG. 1 is a side view of the vehicle 10 on which a control device according to the present disclosure is mounted. FIG. 2 is a top view of the vehicle 10 illustrated in FIG. 1. The vehicle 10 is an example of a moving body of the present disclosure.

The vehicle 10 is an automobile that includes a driving source (not illustrated) and wheels. The wheels include drive wheels driven by power of the driving source and steerable steering wheels. In the present embodiment, the vehicle 10 is a four-wheeled automobile having a pair of left and right front wheels and a pair of left and right rear wheels. The driving source of the vehicle 10 is, for example, an electric motor. The driving source of the vehicle 10 may be an internal combustion engine such as a gasoline engine or a diesel engine, or may be a combination of an electric motor and an internal combustion engine. The driving source of the vehicle 10 may drive the pair of left and right front wheels, the pair of left and right rear wheels, or four wheels of the pair of left and right front wheels and the pair of left and right rear wheels. Both the front wheels and the rear wheels may be steerable steering wheels, or the front wheels or the rear wheels may be steerable steering wheels.

The vehicle 10 further includes side mirrors 11L and 11R. The side mirrors 11L and 11R are mirrors (rearview mirrors) that are provided at outer sides of front seat doors of the vehicle 10 and that allow a driver to check the rear side and rear lateral sides. Each of the side mirrors 11L and 11R is fixed to a body of the vehicle 10 by a rotation shaft extending in the up-down direction, and can be opened and closed by rotating about the rotation shaft. The side mirrors 11L and 11R are electrically opened and closed by an operation of an operation part provided in the vicinity of a driver's seat. A width of the vehicle 10 in a state where the side mirrors 11L and 11R are closed is smaller than a width thereof in a state where the side mirrors 11L and 11R are opened. Therefore, for example, when the vehicle enters a narrow parking space, the side mirrors 11L and 11R are often brought into the closed state so as not to collide with an obstacle in the surroundings.

The vehicle 10 further includes a front camera 12Fr, a rear camera 12Rr, a left lateral-side camera 12L, and a right lateral-side camera 12R. The front camera 12Fr is a digital camera that is provided in a front portion of the vehicle 10 and images a front side of the vehicle 10. The rear camera 12Rr is a digital camera that is provided in a rear portion of the vehicle 10 and images a rear side of the vehicle 10. The left lateral-side camera 12L is a digital camera that is provided in the left side mirror 11L of the vehicle 10 and images a left lateral side of the vehicle 10. The right lateral-side camera 12R is a digital camera that is provided in the right side mirror 11R of the vehicle 10 and images a right lateral side of the vehicle 10. The front camera 12Fr, the rear camera 12Rr, the left lateral-side camera 12L, and the right lateral-side camera 12R are examples of an imaging device of the present disclosure.

<Internal Configuration of Vehicle 10>

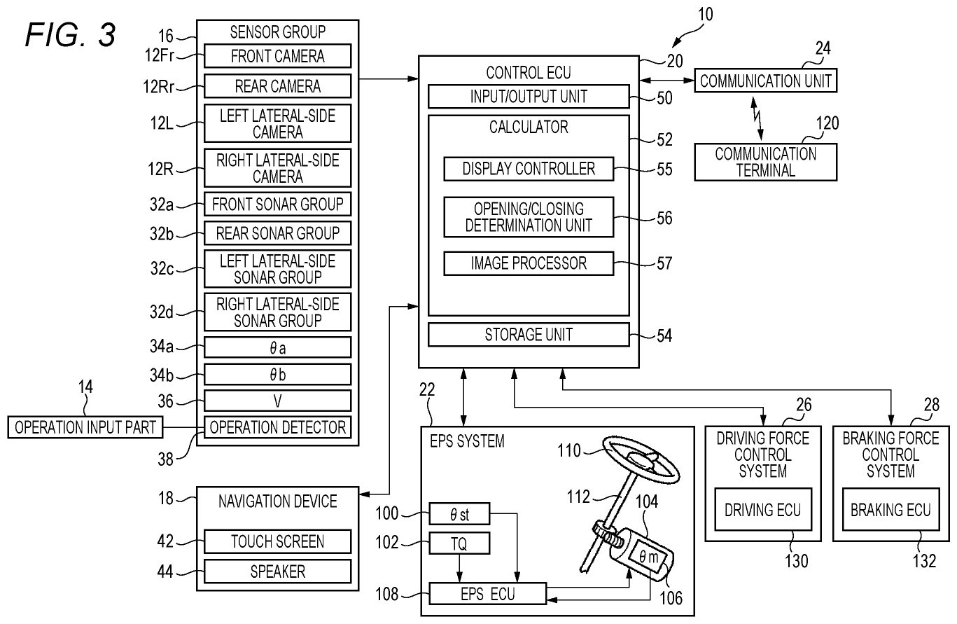

FIG. 3 is a block diagram illustrating an example of an internal configuration of the vehicle 10 illustrated in FIG. 1. As illustrated in FIG. 3, the vehicle 10 includes a sensor group 16, a navigation device 18, a control electronic controller (ECU) 20, an electric power steering (EPS) system 22, and a communication unit 24. The vehicle 10 further includes a driving force control system 26 and a braking force control system 28. The control ECU 20 is an example of a control device of the present disclosure.

The sensor group 16 obtains various types of detection values used for control performed by the control ECU 20. The sensor group 16 includes the front camera 12Fr, the rear camera 12Rr, the left lateral-side camera 12L, and the right lateral-side camera 12R. In addition, the sensor group 16 includes a front sonar group 32a, a rear sonar group 32b, a left lateral-side sonar group 32c, and a right lateral-side sonar group 32d. Further, the sensor group 16 includes wheel sensors 34a and 34b, a vehicle speed sensor 36, and an operation detector 38.

The front camera 12Fr, the rear camera 12Rr, the left lateral-side camera 12L, and the right lateral-side camera 12R output surroundings images obtained by imaging the surroundings of the vehicle 10. The surroundings images captured by the front camera 12Fr, the rear camera 12Rr, the left lateral-side camera 12L, and the right lateral-side camera 12R are referred to as a front image, a rear image, a left lateral-side image, and a right lateral-side image, respectively. An image formed by the left lateral-side image and the right lateral-side image is also referred to as a lateral-side image.

The front sonar group 32a, the rear sonar group 32b, the left lateral-side sonar group 32c, and the right lateral-side sonar group 32d emit sound waves to the surroundings of the vehicle 10 and receive reflected sounds from other objects. The front sonar group 32a includes, for example, four sonars. The sonars constituting the front sonar group 32a are provided at an obliquely left front side, a front left side, a front right side, and an obliquely right front side of the vehicle 10, respectively. The rear sonar group 32b includes, for example, four sonars. The sonars constituting the rear sonar group 32b are provided at an obliquely left rear side, a rear left side, a rear right side, and an obliquely right rear side of the vehicle 10, respectively. The left lateral-side sonar group 32c includes, for example, two sonars. The sonars constituting the left lateral-side sonar group 32c are provided at a front side and a rear side of a left side portion of the vehicle 10, respectively. The right lateral-side sonar group 32d includes, for example, two sonars. The sonars constituting the right lateral-side sonar group 32d are provided at a front side and a rear side of a right side portion of the vehicle 10, respectively.

The wheel sensors 34a and 34b detect a rotation angle of a wheel of the vehicle 10. The wheel sensors 34a and 34b may be implemented using an angle sensor or a displacement sensor. The wheel sensors 34a and 34b output a detection pulse each time the wheel rotates by a predetermined angle. The detection pulse output from the wheel sensors 34a and 34b is used to calculate the rotation angle of the wheel and a rotation speed of the wheel. A movement distance of the vehicle 10 is calculated based on the rotation angle of the wheel. The wheel sensor 34a detects, for example, a rotation angle θa of a left rear wheel. The wheel sensor 34b detects, for example, a rotation angle θb of a right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a countershaft of the transmission.

The operation detector 38 detects what operation is performed by a user using an operation input part 14, and outputs the detected operation that is performed to the control ECU 20. The operation input part 14 includes various user interfaces such as a side mirror switch for switching between an opened state and a closed state of the side mirrors 11L and 11R and a shift lever (a select lever or a selector).

The navigation device 18 detects a current position of the vehicle 10 using, for example, a global positioning system (GPS), and guides the user to a route to a destination. The navigation device 18 includes a storage device (not illustrated) provided with a map information database.

The navigation device 18 includes a touch screen 42 and a speaker 44. The touch screen 42 functions as an input device and a display device of the control ECU 20. The user inputs various commands via the touch screen 42. The touch screen 42 displays various screens. Components other than the touch screen 42, for example, a smartphone may be used as the input device or the display device. The speaker 44 outputs various types of guidance information to an occupant of the vehicle 10 by voice.

The control ECU 20 includes an input/output unit 50, a calculator 52, and a storage unit 54. The calculator 52 is implemented using, for example, a central processing unit (CPU). The calculator 52 performs various types of control by controlling units based on a program stored in the storage unit 54.

The calculator 52 includes a display controller 55, a stop position storage unit 56, and an image processor 57. The image processor 57 generates a surroundings image of the vehicle 10 based on imaging data obtained by the cameras of the vehicle 10. Specifically, the image processor 57 generates a synthesized image by synthesizing respective pieces of imaging data obtained by the front camera 12Fr, the rear camera 12Rr, the left lateral-side camera 12L, and the right lateral-side camera 12R, performs image processing of three-dimensionally reconstructing the synthesized image, and generates a three-dimensional image virtually indicating a space including both the vehicle 10 and the surroundings of the vehicle 10.

The image processor 57 generates a synthesized image by synthesizing respective pieces of imaging data obtained by the front camera 12Fr, the rear camera 12Rr, the left lateral-side camera 12L, and the right lateral-side camera 12R, and based on the synthesized image, generates a bird's-eye view image of the vehicle 10 and the surroundings of the vehicle 10 as viewed from above.

In addition, the image processor 57 sets a mask area in the generated surroundings image (the bird's-eye view image and the three-dimensional image). The mask area refers to an area set to hide the body of the vehicle 10 reflected in a captured image of a camera. The mask area is set as an area having a shape surrounding the vehicle 10. The image processor 57 displays a vehicle image, which indicates the vehicle 10, in a superimposed manner in a portion corresponding to a space in which the vehicle 10 is located in the mask area. The vehicle image is a two-dimensional or three-dimensional image showing a state where the vehicle 10 is viewed from above, and is generated (captured) in advance and stored in the storage unit 54 or the like. The image processor 57 may set a mask area in the lateral-side image (the left lateral-side image and the right lateral-side image) obtained by the left lateral-side camera 12L and the right lateral-side camera 12R.

The image processor 57 enables rotation of a space in the generated three-dimensional image. Rotating a space in a three-dimensional image means generating temporally continuous three-dimensional images so that the space indicated by the three-dimensional images (that is, recognized by the user) is rotated. For example, the image processor 57 enables manual rotation in which the space in the three-dimensional image is manually rotated and automatic rotation in which the space in the three-dimensional image is automatically rotated. In the present embodiment, the manual rotation refers to rotation that is started based on a predetermined operation (for example, an operation of rotating by a predetermined amount) performed by the user, and that continues only during a period in which the predetermined operation is continued. The automatic rotation refers to rotation that is started based on a predetermined operation (for example, an operation of starting automatic rotation) performed by the user, and that continues regardless of whether or not the predetermined operation is continued.

For example, in the manual rotation, a right rotation button and a left rotation button are provided on the touch screen 42, and when the right rotation button is pressed, the space in the three-dimensional image is rotated to the right only during a period in which the right rotation button is being pressed, and when the left rotation button is pressed, the space in the three-dimensional image is rotated to the left only during a period in which the left rotation button is being pressed. In addition, in a case where the space in the three-dimensional image can be rotated by performing swiping on the touch screen 42, the rotation of the space in the three-dimensional image by swiping is included in the manual rotation. Further, inertial rotation, in which the space in the three-dimensional image rotates slightly further before stopping due to inertia of the swiping, is also included in the manual rotation.

In addition, for example, in a case where the space in the three-dimensional image is configured to rotate by 360 degrees based on one press of a rotation button, the rotation based on the press is included in the automatic rotation. In a case where a three-dimensional image for demonstration is rotatably displayed on the touch screen 42 at the time of an on-state of the ignition switch, at the time of idling, or the like, the rotation is included in the automatic rotation.

When the rotation of the three-dimensional image is switched from the manual rotation to the automatic rotation due to an operation by a user riding in the vehicle 10, the image processor 57 starts the automatic rotation from a position that is based on a stop position of the space in the three-dimensional image after the manual rotation. For example, when the rotation of the three-dimensional image is switched from the manual rotation to the automatic rotation by the user's operation, the image processor 57 may start the automatic rotation from the stop position of the space in the three-dimensional image after the manual rotation. In addition, when the rotation of the three-dimensional image is switched from the manual rotation to the automatic rotation by the user's operation, the image processor 57 may start the automatic rotation from a position that is reached by returning and rotating the three-dimensional image by a predetermined amount in a direction opposite to a rotation direction in the manual rotation with respect to the stop position of the space in the three-dimensional image after the manual rotation.

When the rotation of the three-dimensional image is switched from the manual rotation to the automatic rotation by the user's operation, the stop position storage unit 56 stores the stop position of the space in the three-dimensional image after the manual rotation in the storage unit 54. The stop position of the space in the three-dimensional image after the manual rotation is, for example, a rotation position of the space in the three-dimensional image at a time point of switching from the manual rotation to the automatic rotation.

The display controller 55 causes the display device of the vehicle 10 to display the surroundings image generated by the image processor 57. Specifically, the display controller 55 causes the touch screen 42 to display the three-dimensional image and the bird's-eye view image of the vehicle 10 generated by synthesizing the respective pieces of imaging data of the front camera 12Fr, the rear camera 12Rr, the left lateral-side camera 12L, and the right lateral-side camera 12R. In addition, the display controller 55 causes the touch screen 42 to display operation buttons for causing the image processor 57 to execute rotation processing of the three-dimensional image, for example, an automatic rotation button for automatic rotation and a manual rotation button for manual rotation.

Further, the control ECU 20 may perform parking assistance of the vehicle 10 by automatic steering in which the operation of the steering wheel 110 is automatically performed under the control of the control ECU 20. In the assistance of automatic steering, an accelerator pedal (not illustrated), a brake pedal (not illustrated), and the operation input part 14 are automatically operated. In addition, when the user operates the accelerator pedal, the brake pedal, and the operation input part 14 to park the vehicle 10, the control ECU 20 may perform auxiliary assistance.

The EPS system 22 includes a steering angle sensor 100, a torque sensor 102, an EPS motor 104, a resolver 106, and an EPS ECU 108. The steering angle sensor 100 detects a steering angle θst of the steering wheel 110. The torque sensor 102 detects a torque TQ applied to the steering wheel 110.

The EPS motor 104 applies a driving force or a reaction force to a steering column 112 coupled to the steering wheel 110, thereby enabling operation assistance of the steering wheel 110 and automatic steering at the time of parking assistance for the occupant. The resolver 106 detects a rotation angle θm of the EPS motor 104. The EPS ECU 108 controls the entire EPS system 22. The EPS ECU 108 includes an input/output unit (not illustrated), a calculator (not illustrated), and a storage unit (not illustrated).

The communication unit 24 enables wireless communication with another communication device 120. The other communication device 120 is a base station, a communication device of another vehicle, an information terminal such as a smartphone possessed by an occupant of the vehicle 10, or the like.

The driving force control system 26 is provided with a driving ECU 130. The driving force control system 26 executes driving force control of the vehicle 10. The driving ECU 130 controls an engine or the like (not illustrated) based on an operation that the user performs on the accelerator pedal (not illustrated), thereby controlling a driving force of the vehicle 10.

The braking force control system 28 is provided with a braking ECU 132. The braking force control system 28 executes braking force control of the vehicle 10. The braking ECU 132 controls a braking force of the vehicle 10 by controlling a brake mechanism or the like (not illustrated) based on an operation that the user performs on the brake pedal (not illustrated), thereby controlling a braking force of the vehicle 10.

<Rotation Processing on Three-Dimensional Image Performed by Image Processor 57>

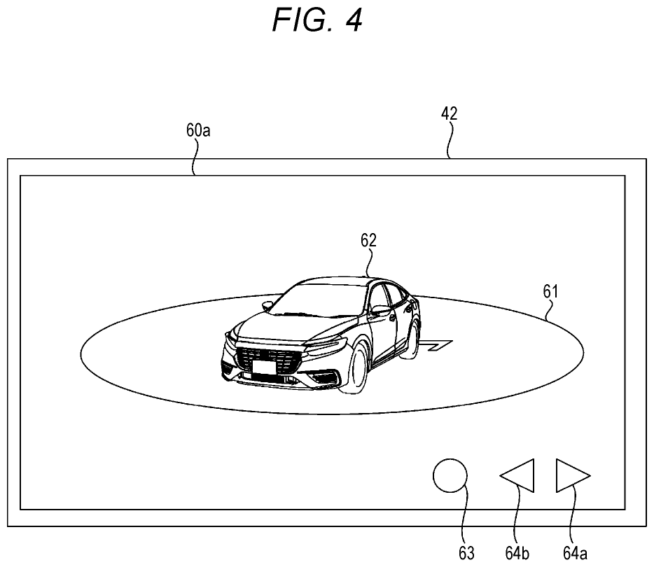

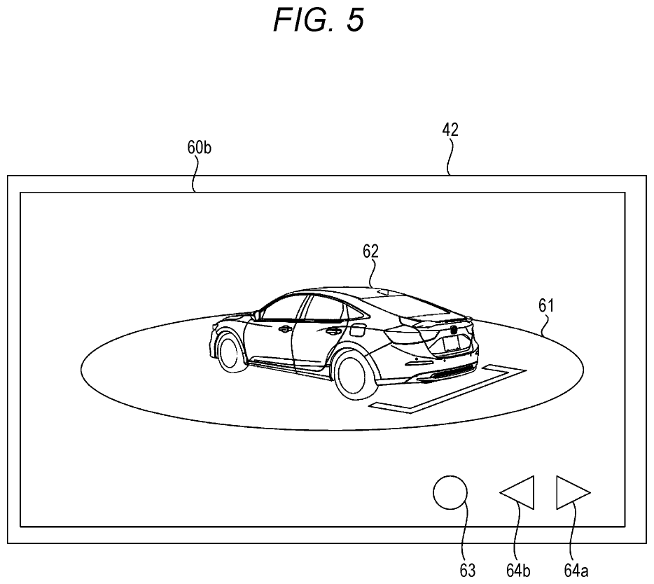

Next, rotation processing on the three-dimensional image displayed on the touch screen 42 will be described with reference to FIGS. 4 and 5. FIG. 4 is a diagram illustrating an example of a three-dimensional image of the vehicle 10 and the surroundings of the vehicle 10 generated from a synthesized image of the respective pieces of imaging data obtained by the front camera 12Fr, the rear camera 12Rr, the left lateral-side camera 12L, and the right lateral-side camera 12R. FIG. 5 is a diagram illustrating a three-dimensional image of the vehicle 10 and the surroundings of the vehicle 10 obtained by rotating the three-dimensional image illustrated in FIG. 4 by a predetermined angle.

As illustrated in FIGS. 4 and 5, a three-dimensional image 60 (three-dimensional images 60a and 60b) displayed on the touch screen 42 includes a three-dimensional surroundings image 61 obtained by performing image processing on a synthesized image of the surroundings of the vehicle 10 so as to appear three-dimensional, and a three-dimensional vehicle image 62 indicating the vehicle 10 displayed in a superimposed manner in a mask area set in the synthesized image of the surroundings.

The three-dimensional image 60a illustrated in FIG. 4 is an image obtained by rotating the vehicle 10 (the three-dimensional vehicle image 62) so as to appear to be viewed from an obliquely upper left front side. The three-dimensional image 60b illustrated in FIG. 5 is an image obtained by rotating the three-dimensional image 60a illustrated in FIG. 4 to the right, for example, and changing the three-dimensional image 60a so that the vehicle 10 appears to be viewed from an obliquely upper left rear side.

An automatic rotation button 63, which is an operation button for automatically rotating the three-dimensional images 60a and 60b, and a right rotation button 64a and a left rotation button 64b, which are operation buttons for manually rotating the three-dimensional images 60a and 60b, are displayed on the touch screen 42.

When the automatic rotation button 63 is pressed, the three-dimensional image displayed on the touch screen 42 is subjected to right rotation or left rotation by 360 degrees, for example. When the automatic rotation button 63 is pressed again during the automatic rotation, the automatic rotation is stopped. Then, when the automatic rotation button 63 is pressed again, the automatic rotation is restarted. A rotation speed of the three-dimensional image in the automatic rotation is set in advance, and may be set by the user.

On the other hand, when the right rotation button 64a is pressed, the three-dimensional image displayed on the touch screen 42 rotates to the right in response to a period in which the pressing operation is performed. In addition, when the left rotation button 64b is pressed, the three-dimensional image displayed on the touch screen 42 rotates to the left in response to a period in which the pressing operation is performed.

<Display Control Performed by Control ECU 20>

Next, display control of a three-dimensional image performed by the control ECU 20 will be described.

[First Example of Display Control]

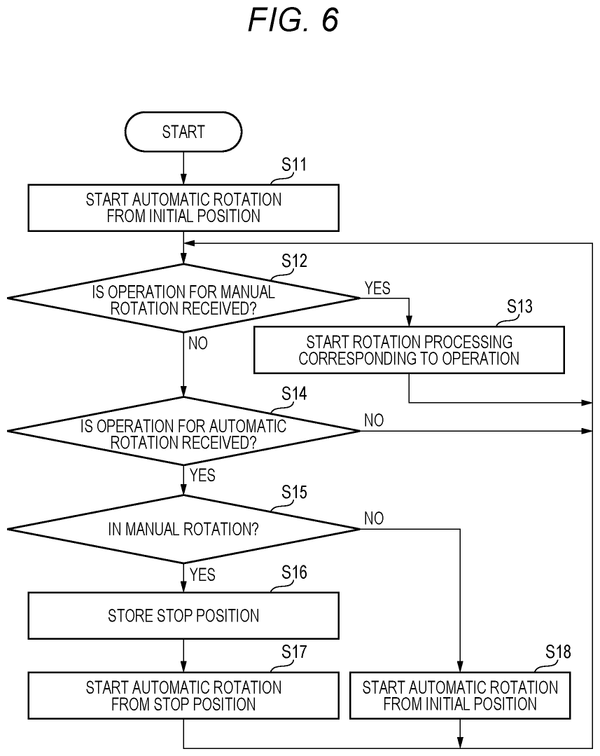

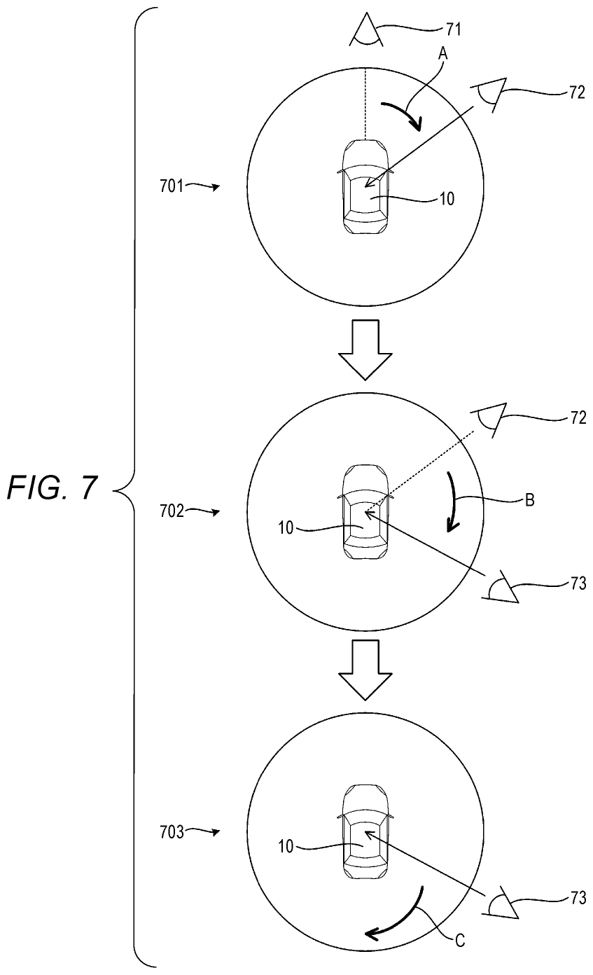

A first example of display control for a three-dimensional image performed by the control ECU 20 will be described with reference to FIGS. 6 and 7. FIG. 6 is a flowchart illustrating the first example of display control for a three-dimensional image performed by the control ECU 20. FIG. 7 is a diagram schematically illustrating a display viewpoint of a three-dimensional image at the time of rotation switching in the display control in FIG. 6. For example, when a three-dimensional image display button (not illustrated) for displaying a three-dimensional image on the touch screen 42 is turned on by an occupant of the vehicle 10, the control ECU 20 starts the processing shown in FIG. 6.

First, the control ECU 20 causes the display controller 55 to display, on the touch screen 42, a three-dimensional image (for example, the three-dimensional image 60a in FIG. 4) indicating a space including both the vehicle 10 and the surroundings of the vehicle 10. Then, the control ECU 20 causes the image processor 57 to start automatic rotation of the space in the displayed three-dimensional image from a preset initial position (step S11).

For example, as illustrated in a state 701 in FIG. 7, the initial position at which the automatic rotation is to be started is set to a position of a viewpoint 71 at which the vehicle 10 is viewed obliquely from a front upper side. When the automatic rotation of the space in the three-dimensional image starts, the position of the viewpoint with respect to the vehicle 10 for displaying the three-dimensional image changes clockwise (in right-handed rotation) from the position of the viewpoint 71 as indicated by an arrow A. The control ECU 20 causes the image processor 57 to generate three-dimensional images of the vehicle 10 viewed from the changing viewpoint, and causes the display controller 55 to display the generated three-dimensional images on the touch screen 42.

Next, the control ECU 20 determines whether an operation for manually rotating the space in the three-dimensional image is received (step S12). Specifically, for example, the control ECU 20 determines whether the right rotation button 64a or the left rotation button 64b displayed on the touch screen 42 in FIG. 4 for performing manual rotation is operated.

When it is determined in step S12 that the operation for manually rotating the space in the three-dimensional image is received (step S12: Yes), the control ECU 20 switches the rotation of the space in the three-dimensional image from the automatic rotation to the manual rotation, and causes the image processor 57 to start rotation processing corresponding to the operation for manual rotation (step S13). That is, the control ECU 20 causes the image processor 57 to rotate the space in the three-dimensional image to the right when the right rotation button 64a is operated, and to rotate the space in the three-dimensional image to the left when the left rotation button 64b is operated.

For example, as illustrated in the state 701 in FIG. 7, it is assumed that the automatic rotation is performed from the position of the viewpoint 71 to a position of a viewpoint 72, and the left rotation button 64b is pressed when the position of the viewpoint 72 is reached. The control ECU 20 stops the automatic rotation of the three-dimensional image at the position of the viewpoint 72, and as illustrated in a state 702, causes the image processor 57 to start the manual rotation of the three-dimensional image from the position of the viewpoint 72 toward a left-right direction as indicated by an arrow B in response to the operation of the left rotation button 64b.

When it is determined in step S12 that the operation for manually rotating the space in the three-dimensional image is not received (step S12: No), the control ECU 20 determines whether an operation for automatically rotating the space in the three-dimensional image is received (step S14). Specifically, for example, the control ECU 20 determines whether the automatic rotation button 63 for performing automatic rotation and displayed on the touch screen 42 in FIG. 4 is operated.

When it is determined in step S14 that the operation for automatically rotating the space in the three-dimensional image is not received (step S14: No), the control ECU 20 returns to step S12. When it is determined that the operation for automatically rotating the space in the three-dimensional image is received (step S14: Yes), the control ECU 20 determines whether the manual rotation started in step S13 is being performed (step S15).

When it is determined in step S15 that the manual rotation is being performed (step S15: Yes), the control ECU 20 causes the stop position storage unit 56 to store a current rotation position of the space in the three-dimensional image as a stop position of the manual rotation in the storage unit 54 (step S16).

Next, the control ECU 20 switches the rotation of the space in the three-dimensional image from the manual rotation to the automatic rotation, reads the “stop position of the manual rotation” stored in step S16 from the storage unit 54, causes the image processor 57 to start the automatic rotation from the stop position (step S17), and returns to step S12.

For example, it is assumed that, with the rotation processing corresponding to the operation for manual rotation in step S13, the position of the viewpoint with respect to the vehicle 10 for displaying the three-dimensional image is changed to reach a position of a viewpoint 73 and the manual rotation is stopped at the position of the viewpoint 73, as illustrated in the state 702 in FIG. 7. The control ECU 20 stores the position of the viewpoint 73 as the stop position of the manual rotation in the storage unit 54. When the operation for automatic rotation is received during the manual rotation, the control ECU 20 reads the position of the viewpoint 73 as the latest stop position of the manual rotation stored in the storage unit 54, and as illustrated in a state 703, causes the image processor 57 to start the automatic rotation of the three-dimensional image clockwise from the position of the viewpoint 73 as indicated by an arrow C.

When it is determined in step S15 that the manual rotation is not being performed (step S15: No), for example, the control ECU 20 switches the rotation of the space in the three-dimensional image from the manual rotation to the automatic rotation, starts the automatic rotation from the preset initial position (step S18), and returns to step S12. In addition, in step S18, in a case where it is after the manual rotation (that is, in a case where the operation for automatic rotation is received after the stop of the manual rotation), the control ECU 20 may cause the image processor 57 to start the automatic rotation from the stop position of the manual rotation.

[Second Example of Display Control]

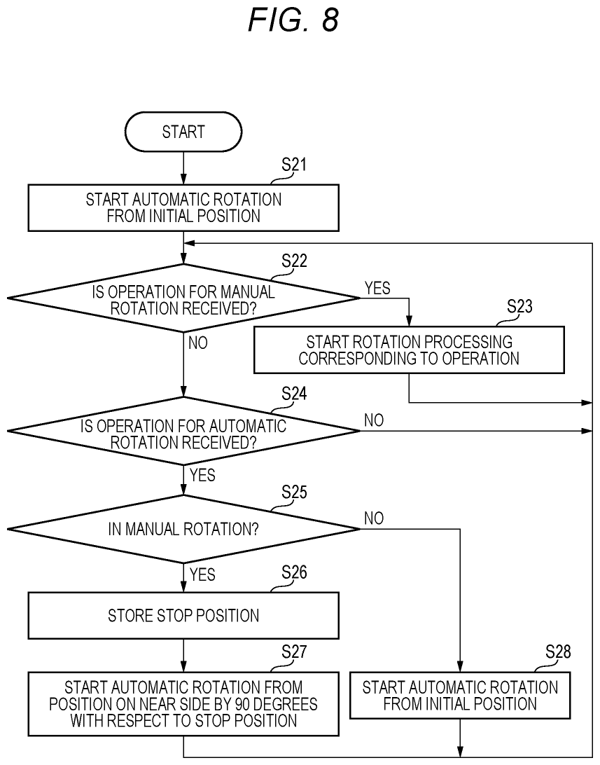

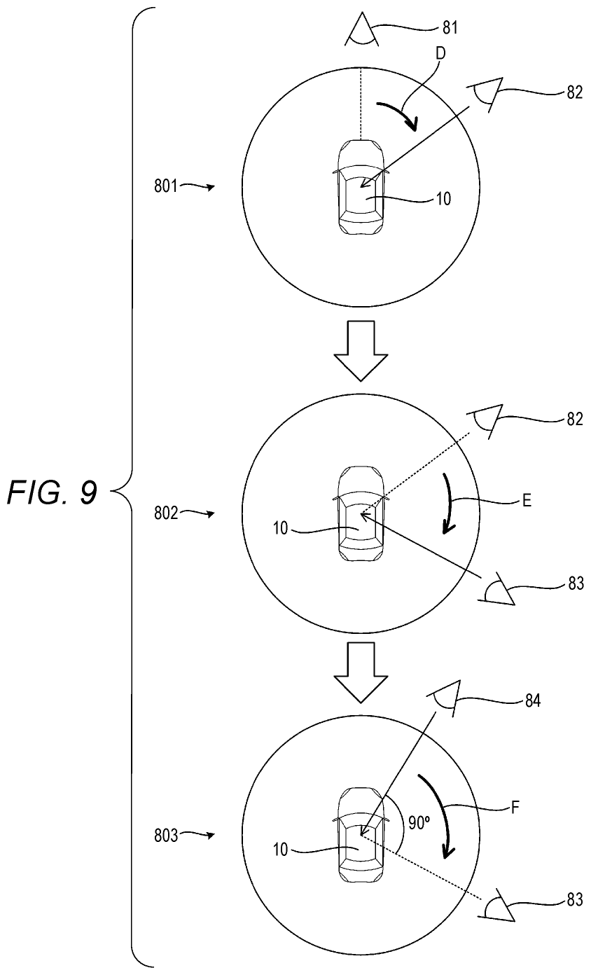

A second example of display control for a three-dimensional image performed by the control ECU 20 will be described with reference to FIGS. 8 and 9. FIG. 8 is a flowchart illustrating the second example of display control for a three-dimensional image performed by the control ECU 20. FIG. 9 is a diagram schematically illustrating a display viewpoint of a three-dimensional image at the time of rotation switching in the display control in FIG. 8. Similarly to the first example of display control described above, for example, when a three-dimensional image display button (not illustrated) is turned on, the control ECU 20 starts the processing shown in FIG. 8.

First, similarly to step S11 in the first example of display control, the control ECU 20 displays a space in a three-dimensional image (for example, see the three-dimensional image 60a in FIG. 4), and starts the automatic rotation of the displayed space in the three-dimensional image from an initial position (step S21).

For example, as illustrated in a state 801 in FIG. 9, the initial position at which the automatic rotation is started is set to a position of a viewpoint 81 at which the vehicle 10 is viewed obliquely from a front upper side, similarly to the first example of display control. When the automatic rotation of the space in the three-dimensional image starts, the position of the viewpoint with respect to the vehicle 10 for displaying the three-dimensional image changes clockwise (in right-handed rotation) from the position of the viewpoint 81 as indicated by an arrow D. The control ECU 20 generates three-dimensional images of the vehicle 10 viewed from the changing viewpoint, and displays the generated three-dimensional images on the touch screen 42.

Next, similarly to step S12 in the first example of display control, the control ECU 20 determines whether an operation for manually rotating the space in the three-dimensional image, for example, an operation on the right rotation button 64a or the left rotation button 64b is received (step S22).

When it is determined in step S22 that the operation for manually rotating the space in the three-dimensional image is received (step S22: Yes), the control ECU 20 switches the rotation of the space in the three-dimensional image from the automatic rotation to the manual rotation, and starts rotation processing corresponding to the operation for the manual rotation (step S23), similarly to step S13 in the first example of display control.

For example, as illustrated in the state 801 in FIG. 9, it is assumed that the automatic rotation is performed from the position of the viewpoint 81 to a position of a viewpoint 82, and the left rotation button 64b is pressed when the position of the viewpoint 82 is reached. The control ECU 20 stops the automatic rotation of the three-dimensional image at the position of the viewpoint 82, and as illustrated in a state 802, causes the image processor 57 to start the manual rotation of the three-dimensional image from the position of the viewpoint 82 toward a left direction as indicated by an arrow E in response to the operation on the left rotation button 64b.

When it is determined in step S22 that the operation for manually rotating the space in the three-dimensional image is not received (step S22: No), the control ECU 20 determines whether an operation for automatically rotating the space in the three-dimensional image, for example, an operation on the automatic rotation button 63 is received (step S24), similarly to step S14 in the second example of display control.

When it is determined in step S24 that the operation for automatically rotating the space in the three-dimensional image is not received (step S24: No), the control ECU 20 returns to step S22. When it is determined that the operation for automatically rotating the space in the three-dimensional image is received (step S24: Yes), the control ECU 20 determines whether the manual rotation started in step S23 is being performed (step S25).

When it is determined in step S25 that the manual rotation is being performed (step S25: Yes), the control ECU 20 causes the stop position storage unit 56 to store a stop position of the manual rotation as the stop position of the manual rotation in the storage unit 54 (step S26).

Next, the control ECU 20 switches the rotation of the space in the three-dimensional image from the manual rotation to the automatic rotation, reads the “stop position of the manual rotation” stored in step S26 from the storage unit 54, starts the automatic rotation, for example, from a position on a near side by 90 degrees with respect to the stop position (a position reached by returning by 90 degrees in the direction of the initial position) (step S27), and returns to step S22. An angle of the near-side position with respect to the stop position is not limited to 90 degrees, and can be arbitrarily set by the user of the vehicle 10.

For example, it is assumed that, with the rotation processing corresponding to the operation for manual rotation in step S23, the position of the viewpoint with respect to the vehicle 10 for displaying the three-dimensional image is changed to reach a position of a viewpoint 83 and the manual rotation is stopped at the position of the viewpoint 83, as illustrated in the state 802 in FIG. 9. The control ECU 20 causes the stop position storage unit 56 to store the position of the viewpoint 83 as the stop position of the manual rotation in the storage unit 54. When the operation for automatic rotation is received during the manual rotation, the control ECU 20 reads the position of the viewpoint 83 as the latest stop position of the manual rotation stored in the storage unit 54. Further, as illustrated in a state 803, the control ECU 20 returns the position of the viewpoint by 90 degrees from the position of the viewpoint 83 to a near-side position of a viewpoint 83, and causes the image processor 57 to start the automatic rotation of the three-dimensional image clockwise from the position of the viewpoint 84 as indicated by an arrow F.

When it is determined in step S25 that the manual rotation is not being performed (step S25: No), for example, the control ECU 20 switches the rotation of the space in the three-dimensional image from the manual rotation to the automatic rotation, starts the automatic rotation from the preset initial position (step S28), and returns to step S22. In addition, in step S28, in a case where it is after the manual rotation (that is, in a case where the operation for automatic rotation is received after the stop of the manual rotation), the control ECU 20 may cause the image processor 57 to start the automatic rotation from a position on a near side by 90 degrees with respect to the stop position of the manual rotation.

As described above, when the rotation is switched, due to the operation by the user of the vehicle 10, from the manual rotation in which the space in the three-dimensional image is manually rotated to the automatic rotation in which the space in the three-dimensional image is automatically rotated, the control ECU 20 starts the automatic rotation from a position that is based on a stop position of the manual rotation. Accordingly, when the rotation is switched from the manual rotation to the automatic rotation by the users operation, the automatic rotation of the three-dimensional image can be started from a position close to a position of a three-dimensional image viewed by the user. Therefore, it is possible to improve visibility of the three-dimensional image at the time when rotation is switched from the manual rotation to the automatic rotation. Therefore, for example, when the vehicle 10 is about to be started from a place where the vehicle 10 is parked or stopped, it is possible to accurately and quickly check whether there is an obstacle in the surroundings of the vehicle 10. In addition, it is possible to accurately and quickly check whether the vehicle 10 collides with the obstacle in the surroundings while the vehicle 10 is entering a narrow parking space or coming out from a narrow parking space. In addition, when the vehicle 10 is entering a narrow parking space, it is easy to check whether there is a space for allowing the occupant of the vehicle 10 to get off the vehicle 10 after the vehicle 10 is stopped. In addition, when the vehicle 10 is stopping, it is easy to check whether there is an obstacle that the occupant of the vehicle 10 comes into contact with at the time of getting off the vehicle 10.

When the rotation is switched from the manual rotation to the automatic rotation by the operation 1w the user of the vehicle 10, the control ECU 20 may cause the image processor 57 to start the automatic rotation from a stop position of the manual rotation. Accordingly, when the rotation is switched from the manual rotation to the automatic rotation by the user's operation, the automatic rotation can be started from a position of a three-dimensional image viewed by the user. Therefore, it is possible to improve visibility of the three-dimensional image at the time when the rotation is switched from the manual rotation to the automatic rotation.

When the rotation is switched from the manual rotation to the automatic rotation by the operation by the user of the vehicle 10, the control ECU 20 may cause the image processor 57 to start the automatic rotation from a position on a near side by a predetermined angle with respect to the stop position of the manual rotation (for example, 90 degrees). Accordingly, when the rotation is switched from the manual rotation to the automatic rotation by the user's operation, the automatic rotation can be started from a position on a near side by a slight amount with respect to a position of a three-dimensional image viewed by the user. Therefore, it is possible to improve visibility of the three-dimensional image at the time when the rotation is switched from the manual rotation to the automatic rotation.

In the control ECU 20, an angle of returning to the near side from the stop position after the manual rotation may be set by the user of the vehicle 10. Accordingly, it is possible to set a position that is easy for the user to see, and it is possible to further improve the visibility.

Although the embodiment of the present disclosure has been described above, the present disclosure is not limited to the above-described embodiment, and modifications, improvements, and the like can be made as appropriate.

For example, although a case has been described in the above-described embodiment in which, when the rotation of the space in the three-dimensional image is switched from the manual rotation to the automatic rotation, the automatic rotation is started from a position reached by returning by a predetermined angle set by the user with respect to a stop position of the space in the three-dimensional image after the manual rotation, the present disclosure is not limited thereto. The predetermined angle for returning from the stop position may be, for example, an angle corresponding to a rotation speed at which the space in the three-dimensional image automatically rotates. Specifically, the returning angle may be decreased when the rotation speed of the automatic rotation is low, and the returning angle may be increased when the rotation speed is high. Accordingly, in a case where the speed of the automatic rotation is low, when the rotation is switched from the manual rotation to the automatic rotation, the automatic rotation can be started from a position close to a position of a three-dimensional image viewed by the user in the manual rotation. Therefore, the visibility at the time when the rotation is switched from the manual rotation to the automatic rotation is improved.

Although a case where the rotation of the three-dimensional image is switched from the manual rotation to the automatic rotation by the user's operation has been described in the above-described embodiment, the present disclosure is not limited thereto. For example, a rotation start position of the automatic rotation may be set even when the rotation of the three-dimensional image is switched from the manual rotation to the automatic rotation under a predetermined condition that does not depend on (namely, independent from) the user's operation. Specifically, for example, there is no need to look at information on the surroundings while the vehicle 10 is traveling stably, and thus the number of operations performed by the user with respect to the display of the three-dimensional image on the touch screen 42 is often small. In this case, when the state in which the operation is not performed continues for a predetermined period of time, the rotation of the three-dimensional image is switched to the automatic rotation, and, for example, a three-dimensional image for demonstration of the vehicle 10 is displayed. Therefore, when the rotation is switched from the manual rotation to the automatic rotation under such conditions, for example, the automatic rotation may be started from a predetermined angle set in advance for the display of the three-dimensional image for demonstration. Further, the three-dimensional image for demonstration may also be displayed on the touch screen 42 at the time of an on-state of the ignition switch of the vehicle 10, at the time of idling, or the like, and also in this case, automatic rotation of the three-dimensional image for demonstration may be started from a predetermined angle.

Although a case where the control ECU 20 displays a three-dimensional image on the touch screen 42 of the vehicle 10 has been described in the above-described embodiment, the present disclosure is not limited thereto. For example, the control ECU 20 may display the three-dimensional image on a display screen of an information terminal (for example, a smartphone) possessed by the occupant of the vehicle 10 via, the communication unit 24.

Although a case where buttons (the automatic rotation button 63, the right rotation button 64a, and the left rotation button 64b) displayed on the touch screen 42 are touch-operated in order to automatically rotate or manually rotate the three-dimensional image has been described in the above-described embodiment, the present disclosure is not limited thereto. For example, the automatic rotation or the manual rotation may be performed by an operation of a mechanical button, an operation based on a voice instruction, or an operation based on a detected line of sight of the driver.

Although a case where imaging data is obtained by a plurality of imaging devices (the front camera 12Fr, the rear camera 12Rr, the left lateral-side camera 12L, and the right lateral-side camera 12R) has been described in the above-described embodiment, alternatively, for example, the imaging data may be obtained by a single 360-degree camera.

Although an example in which the moving body is a vehicle is described in the above-described embodiment, the present disclosure is not limited thereto. The concept of the present disclosure can be applied not only to a vehicle but also to a robot, a boat, an aircraft, and the like that are provided with a driving source and movable by power of the driving source.

The control method described in the above embodiment can be implemented by executing a control program prepared in advance on a computer. The control program is recorded in a computer-readable storage medium and is executed by being read from the storage medium. The control program may be provided in a form stored in a non-transitory storage medium such as a flash memory, or may be provided via a network such as the Internet. The computer that executes the control program may be provided in a control device, may be provided in an electronic device such as a smartphone, a tablet terminal, or a personal computer capable of communicating with the control device, or may be provided in a server device capable of communicating with the control device and the electronic device.

At least the following matters are described in the present specification. Although the corresponding components or the like in the above embodiment are shown in parentheses, the present disclosure is not limited thereto.

(1) A control device, including:

an image processor (image processor 57) that generates, based on imaging data obtained by an imaging device (front camera 12Fr, rear camera 12Rr, left lateral-side camera 12L, and right lateral-side camera 12R) of a moving body (vehicle 10), a three-dimensional image indicating a space including both the moving body and surroundings of the moving body, and enables manual rotation in which the space in the three-dimensional image is manually rotated and automatic rotation in which the space in the three-dimensional image is automatically rotated; and

a display controller (display controller 55) that causes a display device to display the three-dimensional image generated by the image processor,

in which in response to rotation being switched from the manual rotation to the automatic rotation due to an operation by a user of the moving body, the image processor starts the automatic rotation from a position based on a stop position of the space after the manual rotation.

According to (1), in response to the rotation being switched from the manual rotation to the automatic rotation due to the user's operation, the automatic rotation can be started from a position close to a position viewed by the user, and thus visibility of the three-dimensional image at the time when the rotation is switched from the manual rotation to the automatic rotation can be improved.

(2) The control device according to (1),

in which in response to the rotation being switched from the manual rotation to the automatic rotation due to the operation by the user of the moving body, the image processor starts the automatic rotation from the stop position of the space after the manual rotation.

According to (2), in response to the rotation being switched from the manual rotation to the automatic rotation due to the user's operation, the automatic rotation can be started from a position viewed by the user, and thus the visibility of the three-dimensional image at the time when the rotation is switched from the manual rotation to the automatic rotation can be improved.

(3) The control device according to (1),

in which in response to the rotation being switched from the manual rotation to the automatic rotation due to the operation by the user of the moving body, the image processor starts the automatic rotation from a position that is reached by rotating by a predetermined amount in a direction opposite to a rotation direction in the manual rotation with respect to the stop position of the space after the manual rotation.

According to (3), in response to the rotation being switched from the manual rotation to the automatic rotation by the user's operation, the automatic rotation can be started from a position reached by returning by a small amount from a position viewed by the user, and thus the visibility of the three-dimensional image at the time when the rotation is switched from the manual rotation to the automatic rotation can be improved.

(4) The control device according to (3),

in which the predetermined amount is an amount set by the user of the moving body.

According to (4), it is possible to set a position that is easy for the user to see, and it is possible to improve the visibility.

(5) The control device according to (3) or (4),

in which the predetermined amount is an amount corresponding to a speed of the automatic rotation.

According to (5), in response to the rotation being switched from the manual rotation to the automatic rotation by the user's operation, the automatic rotation can be started from a position, which is easy for the user to see, according to the speed of the automatic rotation, and thus the visibility of the three-dimensional image at the time when the rotation is switched from the manual rotation to the automatic rotation can be improved.

(6) The control device according to any one of (1) to (5),

in which the automatic rotation is started from a preset initial position when the rotation is switched from the manual rotation to the automatic rotation under a predetermined condition independent from the operation by the user of the moving body.

According to (6), even when the rotation is switched from the manual rotation to the automatic rotation without the user's operation, the visibility can be improved.

(7) The control device according to any one of (1) to (6),

in which the imaging device includes a plurality of imaging devices, and

in which the three-dimensional image is an image generated by synthesizing respective pieces of imaging data obtained by the plurality of imaging devices.

According to (7), a driver can intuitively grasp a state of the surroundings of the vehicle.

(8) A control method to be executed by a processor, the processor being configured to generate, based on imaging data obtained by an imaging device of a moving body, a three-dimensional image indicating a space including both the moving body and surroundings of the moving body, enable manual rotation in which the space in the three-dimensional image is manually rotated and automatic rotation in which the space in the three-dimensional image is automatically rotated, and display the generated three-dimensional image on a display device, the control method including:

starting the automatic rotation from a position based on a stop position of the space after the manual rotation in response to rotation being switched from the manual rotation to the automatic rotation due to an operation by the user of the moving body.

According to (8), when the rotation is switched from the manual rotation to the automatic rotation by the user's operation, the automatic rotation can be started from a position close to a position seen by the user, and thus visibility of the three-dimensional image at the time when the rotation is switched from the manual rotation to the automatic rotation can be improved.

(9) A control program for causing a processor to perform processing, the processor being configured to generate, based on imaging data obtained by an imaging device of a moving body, a three-dimensional image indicating a space including both the moving body and surroundings of the moving body, enable manual rotation in which the space in the three-dimensional image is manually rotated and automatic rotation in which the space in the three-dimensional image is automatically rotated, and display the generated three-dimensional image on a display device, the processing including:

starting the automatic rotation from a position based on a stop position of the space after the manual rotation in response to rotation being switched from the manual rotation to the automatic rotation due to an operation by the user of the moving body.

According to (9), when the rotation is switched from the manual rotation to the automatic rotation by the user's operation, the automatic rotation can be started from a position close to a position viewed by the user, and thus visibility of the three-dimensional image at the time when the rotation is switched from the manual rotation to the automatic rotation can be improved.

1. A control device, comprising
circuitry configured to:
generate, based on imaging data obtained by an imaging device of a moving body, a three-dimensional image indicating a space including both the moving body and surroundings of the moving body; and
cause a display device to display the generated three-dimensional image,
wherein the circuitry is capable of manual rotation in which the space in the three-dimensional image is manually rotated and automatic rotation in which the space in the three-dimensional image is automatically rotated, and
wherein in response to rotation being switched from the manual rotation to the automatic rotation due to an operation by the user of the moving body, the circuitry starts the automatic rotation from a position that is based on a stop position of the space after the manual rotation.

2. The control device according to claim 1,
wherein in response to the rotation being switched from the manual rotation to the automatic rotation due to the operation by the user of the moving body, the circuitry starts the automatic rotation from the stop position of the space after the manual rotation.

3. The control device according to claim 1,
wherein in response to the rotation being switched from the manual rotation to the automatic rotation due to the operation by the user of the moving body, the circuitry starts the automatic rotation from a position that is reached by rotating, with respect to the stop position of the space after the manual rotation, by a predetermined amount in a direction opposite to a rotation direction in the manual rotation.

4. The control device according to claim 3,
wherein the predetermined amount is an amount set by the user of the moving body.

5. The control device according to claim 3,
wherein the predetermined amount is an amount corresponding to a speed of the automatic rotation.

6. The control device according to claim 1,
wherein the automatic rotation is started from a preset initial position when the rotation is switched from the manual rotation to the automatic rotation under a predetermined condition independent from the operation by the user of the moving body.

7. The control device according to claim 1,
wherein the imaging device includes a plurality of imaging devices, and
wherein the three-dimensional image is an image generated by synthesizing respective pieces of imaging data obtained by the plurality of imaging devices.

8. A control method to be executed by a processor, comprising:
generating, based on imaging data obtained by an imaging device of a moving body, a three-dimensional image indicating a space including both the moving body and surroundings of the moving body and
displaying the generated three-dimensional image on a display device, wherein the processor is capable of manual rotation in which the space in the three-dimensional image is manually rotated and automatic rotation in which the space in the three-dimensional image is automatically rotated, and
wherein the control method further comprises starting the automatic rotation from a position that is based on a stop position of the space after the manual rotation, in response to rotation being switched from the manual rotation to the automatic rotation due to an operation by the user of the moving body.

9. A non-transitory computer-readable recording medium storing a control program for causing a processor to perform processing, the processing comprising:
generating, based on imaging data obtained by an imaging device of a moving body, a three-dimensional image indicating a space including both the moving body and surroundings of the moving body; and
displaying the generated three-dimensional image on a display device,
wherein the processor is capable of manual rotation in which the space in the three-dimensional image is manually rotated and automatic rotation in which the space in the three-dimensional image is automatically rotated, and
wherein the processing further comprises starting the automatic rotation from a position that is based on a stop position of the space after the manual rotation, in response to rotation being switched from the manual rotation to the automatic rotation due to an operation by the user of the moving body.
